(19) United States
(12) Patent Application Publication
(10) Pub. No.: US 2015/0073931 A1
(43) Pub. Date: Mar. 12, 2015

(54) FEATURE SELECTION FOR RECOMMENDER SYSTEMS

(71) Applicant: Microsoft Corporation, Redmond, WA (US)

(72) Inventors: Royi Ronen, Tel Aviv (IL); Noam Koenigstein, Ra'anana (IL); Nir Nice, Kfar Vitkin (IL); Elad Ziklik, Modi'in (IL)

(73) Assignee: Microsoft Corporation, Redmond, WA (US)

(21) Appl. No.: 14/020,659

(22) Filed: Sep. 6, 2013

(51) Int. Cl. G06Q 30/06

(52) U.S. Cl. CPC G06Q 30/0631
USPC 705/26.7

(57) ABSTRACT

Disclosed herein is a system and method for identifying features of items that are more relevant for making recommendations to consumers for content that they may be interested in. The system determines the similarity between items that are recommend and items in the user's history and compares that similarity measure to the similarity measure calculated for a random item on the same features. From this similarity measure the relative impactfullness of a particular feature on a recommendation can be determined.

### TECHNICAL FIELD

This description relates generally to determining which features from a group of features are most relevant in making a recommendation to a group of consumers through a marketplace.

### BACKGROUND

Marketplaces have historically provided users with a list of recommended items that the user may be interested in. However, these recommendations have historically been based off of the relationships between items. Typically this has been in the form of “people who have bought this have also bought these items”. More advanced systems of recommendations look at the items themselves to determine if the items are related and the user may be interested in the items based on a similarity between the item being looked at and these items. However, these recommendations require that items have been in the system for a long period of time for the system to be able to make the correct associations. Further, these recommendations will often omit newly added items in the marketplace because there is not enough history for the items. Further, simply matching the new items with like items in the marketplace often matches items incorrectly because of the lack of knowledge about why or what causes consumers to select these related items.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

The present example provides a system and method for determining which features among a group of features for an item are most relevant for recommending items to a specific set of consumers. A group of users is selected from a user database and a set of recommendations for each of those users are determined. The recommendations are then compared against a history of items for those users. The present disclosure considers each feature of each item in the history against each item in the recommendations. From this analysis a relevance score for each feature is calculated that indicates which features were most relevant in creating a good recommendation. An administrator of the marketplace can review the results of the comparisons and determine why certain features were found more relevant than others and also select those features that the administrator desires to have used for incorporating cold items into the recommendations.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram illustrating an example recommender system according to one illustrative embodiment.

FIG. 2 is a block diagram illustrating components of a feature selection and scoring for a recommender system according to one illustrative embodiment.

FIG. 3 is a flow diagram illustrating a process for selecting features that are used by a recommender system for presenting recommendations to a user according to one illustrative embodiment.

FIG. 4 is a flow diagram illustrating an exemplary process for selecting features and tuning the recommendation engine according to one illustrative embodiment.

FIG. 5 illustrates the results of the attribute scoring for movies attributes across one example dataset.

FIG. 6 illustrates the results of the scoring process for movie labels across on example dataset.

FIG. 7 illustrates a component diagram of a computing device according to one embodiment.

Like reference numerals are used to designate like parts in the accompanying drawings.

### DETAILED DESCRIPTION

People typically consume content such as movies and video games on their computing devices. These consumers often buy or obtain content from a marketplace of providers. These marketplaces often make recommendations to consumers about content that the provider has determined may be of interest to this consumer. This is typically done by presenting to the user of a list of recommended items that others who are looking at the current content have also been interested in. In some more advances systems a profile for the consumer may also be used to provide better recommendations to the user. One such system that makes use of the consumer's personalized profile is discussed in co-pending U.S. Pat. No. ______ filed ______, entitled INCORPORATING USER USAGE OF CONSUMABLE CONTENT INTO RECOMMENDATIONS the contents of which are incorporated by reference herein in their entirety. Further, the consumer may have a large amount of consumable content already stored or otherwise available to them that they may have also forgotten about.

When making recommendations to consumers regarding content that the consumer may be interested in recommender systems make use of the consumer's profile as well as information about the particular items of content that are in the marketplace. This information is often contained as metadata that describes various features about a particular item. When potential matches are found between the consumer's profile and items in the marketplace the consumer is often presented with a statement such as “customers like you have also liked X”. It is through this approach that marketplaces are able to quickly suggest other items for the consumer to consider and purchase.

When new items are added to the marketplace they often lack enough history for them to be incorporated successfully into the recommendation systems. This is commonly referred to as a cold item. Cold items are items that have a limited amount of consumer interaction with and therefore, it is not known how relevant a cold item may be to a particular user profile. An item remains “cold” until such time as the marketplace and the recommender system learn enough about other consumers' interactions with that item to properly manage it.

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. This is distinct from computer storage media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

Collaborative Filtering (CF) recommender systems have become a must-have for large digital marketplaces such as Amazon, Ebay and the Xbox Live Marketplace. While CF algorithms are usually more accurate than content-based algorithms, they suffer from the ‘cold-start’ problem. That is the situation where a particular item that has been added to a marketplace may not have enough usage, consumption or purchasing for the recommender system to know what users would be interested in that particular item. It is only after an item has been accessed a number of times can typical recommender systems determine which users may be interested in the new item. Meta-data in the form of features, has been used by several CF algorithms for mitigating the cold-start problem and for improving accuracy in general. However, they have struggled with the problem of determining which features are actually relevant for recommendations and which features are merely noise. Features are also highly useful for providing explanations to recommendations and for visualization.

The present disclosure addresses the problem of evaluating the quality of meta-data features. The algorithmic framework discussed herein is independent of any specific recommendation algorithm. Instead, the recommendation algorithm and other parameters are pluggable variables of the system. Two types of algorithms are discussed. First is an algorithm for scoring meta-data attributes, and second is an algorithm for scoring meta-data labels. Both algorithms can be used to enhance recommendations in a marketplace that makes use of recommendations in suggesting content to a user such as in the Xbox Live marketplace.

The item catalog in a recommender system is typically equipped with meta-data features in the form of attributes. These attributes may be numerical, categorical, ordinal, binary, etc. For example, the attributes genre, price, and year of publication in a movie catalog. Another form of features are labels, or tags, assigned to items by consumers, experts, or extracted from text using an algorithm. A label is usually a word or a short phrase describing the item. The labels form a closed set or dictionary of labels and every item may or may not be assigned any label (the tag-of-words' format). Some examples of movie labels are: boring, cool-stuff and feel-good. However, any label description can be used if it provides a way to associate items into some form of category.

While some features are highly informative with regard to the recommendation task (e.g., genre), many others are often redundant or irrelevant (e.g., cover color). Though in some instances a feature that initially appears redundant or irrelevant may later be determined to be relevant. The present disclosure uses content-based features to enhance any CF system.

Roughly speaking, a feature selection algorithm belongs to one of three categories: wrapper methods, filter methods, or embedded methods. Filter methods typically evaluate a large number of different subsets of features by training a model on each subset and scoring on a held-out set. This approach is independent of the prediction algorithm in use, but is usually too expensive for large-scale recommender systems and for large sets of features. Filter methods use heuristic measures such as mutual information or Pearson Correlation to score features based on their informative power with regard to the prediction target. These methods are also independent of the algorithm in use. They do not require the training of many models, and therefore scale well for large models with a high number of features. However, these methods cannot be naturally extended to recommender systems where the prediction target varies and depends both on the user's history and on the item under consideration. The present disclosure provides a framework and methods which permit the extension of these selection algorithms to a recommender system.

The last category, embedded methods, is a family of algorithms in which feature selection is performed in the course of model construction. Unlike filter methods, they are not based on cross validation and therefore scale with the size of the usage data. However, since feature selection is inherent to modeling, each such method is tightly coupled with the specific algorithm in use. When the recommendation algorithm is replaced, the feature selection algorithm needs to be reconsidered. Furthermore, depending on the algorithms, embedded methods may not scale well with a large number of features (despite scaling with usage).

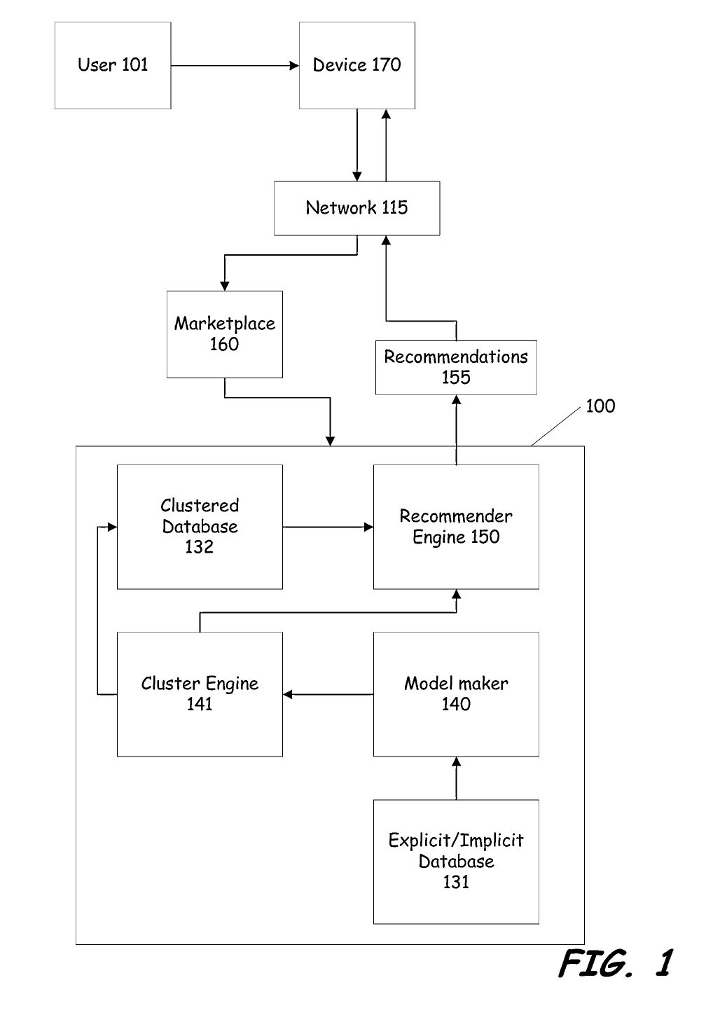

FIG. 1 schematically shows a recommender system 100 operating to provide recommendations 155 to users such as user 101, that may access the recommender system 100 through a marketplace, such as marketplace 160 using a device 170 according to one illustrative embodiment. However, any available recommender system may be used. Recommender system 100 in some embodiments comprises an “explicit-implicit database” 131 comprising explicit and/or implicit data acquired responsive to preferences exhibited by a population of users 101 for items in a catalog of items. Recommender system 100 may comprise a model maker 140 and a cluster engine 141 that cooperate to cluster related catalog items in catalog clusters and generate a clustered database 132. A recommender engine 150 recommends catalog items from catalog clusters in clustered database 132.

Device 170 may be any device in which a user 101 interacts with the marketplace 160 through a network 115 to receive recommendations 155 for content. (e.g. mobile phone, tablet computer, desktop computer, music player, etc) The marketplace 160 is in one embodiment a consumer marketplace 160 accessed by consumers or users 101 to purchase or obtain content and have that content delivered to them via network 115. The marketplace 160 permits the user to search for content and also provides recommendations to the user about content they may be interested in by communicating with a recommender system 100.

Explicit data optionally comprised in explicit-implicit database 131 includes information acquired by recommender system 100 responsive to explicit requests for information submitted to users 101 in the population. These requests can be obtained in one embodiment from the user 101 when the user generates their personal profile with the marketplace or first interacts with the device 170. Explicit requests for information may comprise, for example, questions in a questionnaire, requests to rank a book or movie for its entertainment value, requests to express an opinion on quality of a product, or requests to provide information related to likes and dislikes. Implicit data in the explicit-implicit database 131 can includes data acquired by the recommender system 100 responsive to observations of behavior of users 101 in the population that is not consciously generated by an explicit request for information. For example, implicit data may comprise data responsive to determining how the user uses content displayed by the device 170.

Model maker 140 processes explicit and/or implicit data comprised in explicit-implicit database 131 to implement a model for representing catalog items that represents each of the catalog items by a representation usable to cluster the catalog items. Cluster engine 141 processes the representations of the catalog items provided by model maker 140 to generate “clustered database” 132 in which the plurality of catalog items is clustered into catalog clusters, each of which groups a different set of related catalog items. While FIG. 1 schematically shows explicit-implicit database 131 as separate from clustered database 132, clustered database 132 may be comprised in explicit-implicit database 131. To generate clustered database 132, cluster engine 141 may for example simply mark records in explicit-implicit database 131 to indicate clusters with which the records are associated.

Any of various models for providing representations of catalog items and methods of processing the representations to cluster the catalog items and generate clustered database 132 may be used in practice of an embodiment of the invention. Model maker 140 may for example generate representations of catalog items that are based on feature vectors. Optionally, model maker 140 represents catalog items by vectors in a space spanned by eigenvectors, which are determined from a singular value decomposition (SVD) of a “ranking matrix” representing preferences of users 101 for the catalog items. Model maker 140 may represent catalog items by trait vectors in a latent space determined by matrix factorization of a ranking matrix. However, other methods may be employed.

Cluster engine 141 optionally clusters catalog items in a same catalog cluster if same users exhibit similar preferences for the catalog items. Optionally, cluster engine 141 uses a classifier, such as a support vector machine, trained on a subset of the catalog items to distinguish catalog items and cluster catalog items into catalog clusters. In an embodiment of the invention, cluster engine 141 uses an iterative k-means clustering algorithm to cluster vectors representing catalog items and generate clustered database 132.

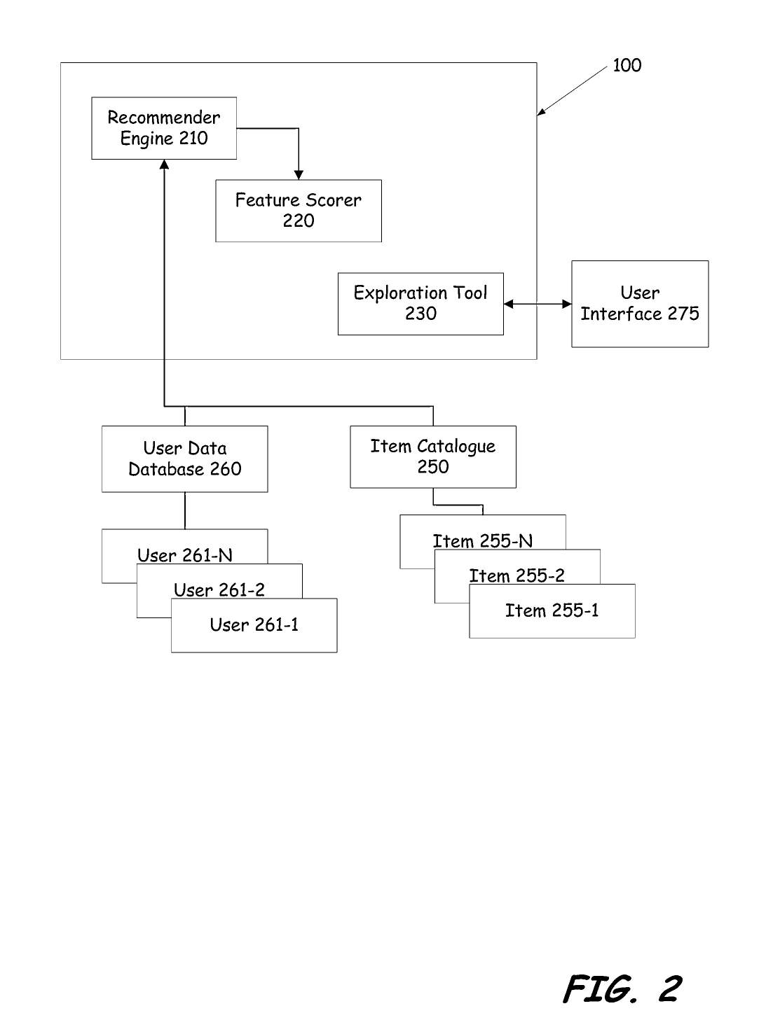

FIG. 2 is a block diagram that illustrates the components of a recommender system 100 incorporating the features of the present disclosure to identify and select features to be used in the recommender system to provide more relevant recommendations to users. The system 100 includes a recommender engine 210, a feature scorer 220 and an exploration tool 230. Recommender system 100 further includes or accesses an item library or catalogue 250 and user data database 260. FIG. 1 illustrates the consumer/user 101 interacting with the marketplace and recommender system 100 whereas FIG. 2 illustrates the tuning of the recommender system100.

Item library or item catalogue 250 is in one embodiment a database or other storage system that allows for the storage and maintaining of items that are available through a marketplace that a consumer interacts with to obtain consumable content and/or recommendations from. In the item library is a plurality of items 255, each item 255 is associated with a particular piece of consumable content. In order to categorize and find items in the item catalogue each item has a plurality of features 256 associated with the item. The features 256 can include attributes such as subject, location, genre, audience, environment, time period, scenes, comments, popularity, etc. It should be noted that the features 256 can include any attribute that provides insight about the content. An item 255 may have any number of features 256 associated with it. Further, each attribute includes a label. A label is a value that is associated with a particular attribute/feature. A label can be either numerical or alpha, such as a word, phrase or sentence. The values of the attributes are often presented to a consumer when they view a summary listing for the associated item 255 in a marketplace. However, the number of attributes present for a particular item may be extremely large such that certain features/attributes are more relevant in making suggestions/recommendations to a consumer.

User data database 260 is in one embodiment a database or other data storage system that allows for the storage and maintaining of data related to consumer users of the marketplace. The user data database may in one embodiment contain a history of items the consumer has purchased in the past from the marketplace, items that the use has looked at in the past, comments the consumer has made regarding particular items, or any other information that is usable by the marketplace and the recommender system to generate a profile about a particular consumer and to make content recommendations to that user.

The recommender engine 210 is a component that is responsible for modeling CF usage data and providing recommendations to a user in response to the user engaging with marketplace 160. In one embodiment a probabilistic matrix factorization model is used as the recommender engine 210. However any recommendation engine can be ‘plugged-in’ instead.

The feature scorer 220 is a component that scores and ranks features for data items using the framework of the present disclosure. In one embodiment the feature scorer 220 uses implicit feedback recommendation algorithms. The implicit feedback recommendation algorithm is useful in commercial settings where a marketplace is used. In some embodiments the feature scorer 220 uses explicit feedback as well (i.e., ratings) within the chosen algorithm.

The exploration tool 230 is a component of the recommender system100 that is used to present the results of the features scoring and of model visualization. The results can be displayed to a user or administrator through a user interface 275 such that the user or administrator can understand the relationships between various features and the effects that each of the features has on making recommendations to a user or consumer. This is the front-end of the system with which the user can interactively explore features, including automatic feature extraction from textual item descriptions. This may be done using a user interface on any computing system. An example process of using the exploration tool 230 is illustrated with respect to FIG. Y.

The feature scorer 220 makes a distinction between two types of item features: attributes and labels. Attributes, are denoted by s.a the value that item s has for the attribute a. Labels are denoted by s:L the set of labels associated with the item s (‘bag-of-words’). The present algorithms use an abstract similarity function sim (*,*) between two attribute values or between two labels, where * represents a value or a label upon which the similarity is being determined. The similarity function sim(*,*) in one embodiment may be based either on the actual values (for example, sim(f₁; f₂)=δ(f₁; f₂) which equals 1 if f₁=f₂ and 0 otherwise). In an alternative embodiment it may be based on some CF measure (for example, cosine similarity based on users who purchased items with features f₁ and f₂).

The users history is denoted by the equation Hᵤ={hᵤ₁; hᵤ₂, . . . , hₙ} the set of n items in user u's history. The set Hᵤ is used by an implicit-feedback recommender to produce a set of k recommended items denoted by Rₖ(Hᵤ)={rᵤ₁; rᵤ₂, . . . , rᵤₖ.} In embodiments using the explicit-feedback case, Hᵤ is also associated with ratings.

The feature scorer 220 can use any similarity function such as cosine similarity of Jacard similarity functions for determining the similarity between two features. Further, the feature scorer 220 can use any recommendation algorithm to generate the set of recommendations for comparison. The selection of the specific algorithm or similarity function that is used by the feature scorer 220 may be based on the desires of the operator of the recommendation engine so that specific operator goals can be achieved.

In the present embodiments the feature scorer 220 performs feature selection by using two algorithms. The first algorithm is an algorithm that is used for scoring attributes or categories and the second algorithm is used for scoring labels. This process of feature selection is achieved by computing a relevance score for each feature and then selecting the highest-scoring (i.e., most informative) features using the appropriate algorithm. The process of these algorithms will be discussed below with respect to Fig X.

Both algorithms, in one embodiment, are based on the ratio between two variables b₁ and b₂. b₁ is proportional to the similarity of the feature with respect to relevant items according to Rₖ(_). b₂ is proportional to the similarity of the feature with respect to random items. Therefore, according to one embodiment, the ratio of b₁=b₂ measures the normalized relevance of the feature with regard to recommended items.

These methods generalize the lift-based feature selection, widely used outside the context of recommendation systems. For the embodiment where sim(v₁;v₂)=δ(v₁;v₂), b₁ counts co-occurrences of a feature in histories and in relevant recommendations. Similarly, b₂ counts co-occurrences of the feature in histories and in random items. Let E₁ be the event where a recommended item r is a ‘good’ recommendation to a user with history Hᵤ. In one embodiment a good recommendation is one that appears in the top-k recommendations. Let E₂ be the event where a recommended item r, is not necessarily ‘good’ as defined above, but has the same feature as an item in Hᵤ. As such result are shown that ranking according to b₁=b₂ is identical to ranking according to the empirical lift(E₁=>E₂):

$$lift ( E 1 ⇒ E 2 ) {=}^{def} \frac{Pr ( E 2 \vert E 1 )}{Pr ( E 2 )} = \frac{b 1}{b 2} \qquad Equation 1$$

More expressive similarity functions sublimate the scoring, as is discussed further.

The feature scorer 220 in one embodiment evaluates feature scoring using a cold item representation task for matrix factorization (MF) models. MF models represent items and users by trait vectors in a low dimensional latent space. In the present embodiments a random item vector from the model is removed and its trait vector is reconstructed based on other item vectors having the similar features (e.g. labels or attribute values) as the removed item. This reconstruction process is repeated, each time evaluating different feature f. Formally, let qᵢ be the item vector of a removed item i. This finds a set of items S_{f}(i) whose feature (values are similar to that of item i's value for feature f. The feature scorer 220 then computes a reconstructed vector qᵢ^{f} for i according to f as follows:

$${q}_{i}^{f} = \frac{1}{\vert {s}_{f} ( i ) \vert} {\sum }_{j ∈ {s}_{f} ( i )}^{ } {q}_{j} \qquad Equation 2$$

The quality of this reconstruction according to the Root Mean Squared Error (RMSE):

$$RMSE ( f ) = \sqrt{\frac{1}{N} {\sum }_{i = 1}^{N} {‖ {q}_{i} - {\hat{q}}_{i}^{f} ‖}^{2}} \qquad Equation 3$$

This reconstruction process used by the present embodiments is based on a cold-start problem for items. When a new item i is introduced into the catalog, the feature scorer 220 constructs a trait vector for the new item in order to integrate the item into the existing models even before having any usage data for i is obtained. It should be noted that while this evaluation process is applicable to the cold-start representation problem for items in a MF model, the feature scoring framework used by the feature scorer 220 disclosed herein is general to any task and any recommendation algorithm.

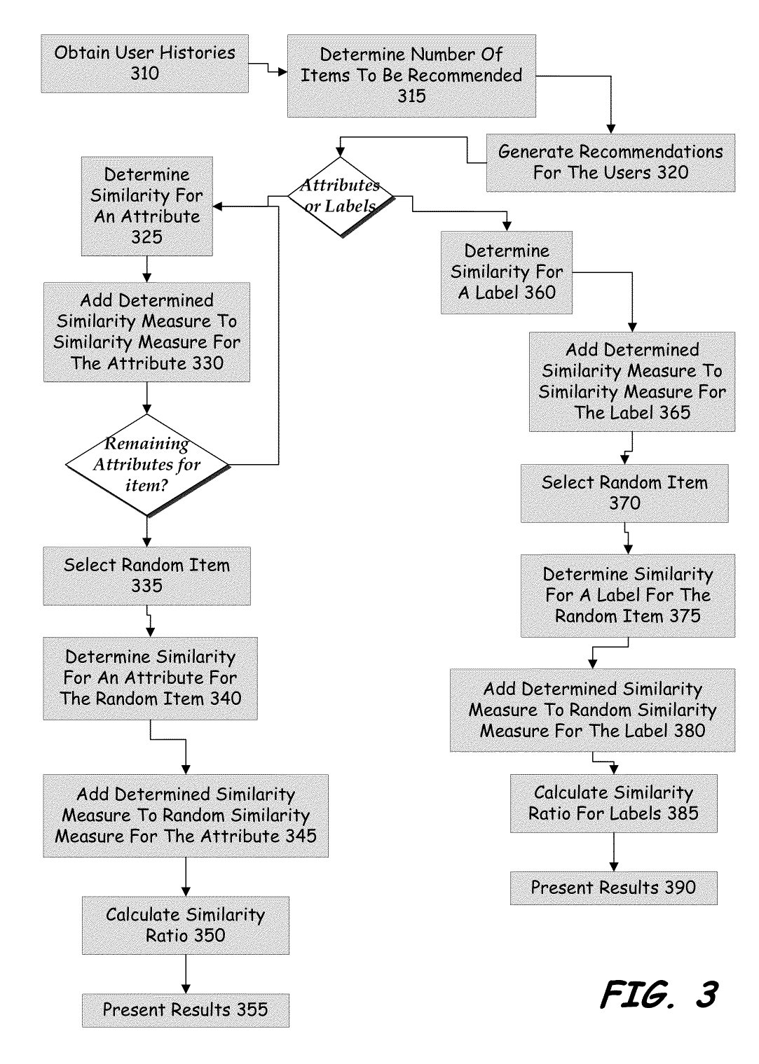

FIG. 3 is a flow diagram illustrating a process for selecting features that are used by a recommender system 100 for presenting recommendations to a user. The process begins by collecting a number of histories for a number or plurality of users from the user data database 260. The users can be selected based on a common demographic, characteristic, or portion(s) of a user's profile. This allows for the administrator to consider that different features may be more important for certain groups or sets of users than for other users. (e.g. 20 year old males are likely to have different relevant features than 60 year old women, science fiction fans may have a different set of relevant features than sports fans, etc). The histories for each user in the number of users is based on items or content that each of the users has purchased or consumed from the associated marketplace 160. Thus for each user 261-1, 261-N in the number of users a profile is obtained. For each item 255-1, 255-N in the user's history that the user 261 has purchased or consumed various pieces of data and metadata about the item 255 are provided. This can include for example for a book data related to the title of the book, the author of the book, the genre of the book and the year of publication of the book. Further information that may be associated with the item includes when the user purchased the item, how the user used the item, etc. Depending on the particular type of item different data may be associated with the item. The acquisition of the user histories is illustrated at step 310.

Once the histories for a number of users are received by the feature scorer 220, the process continues by determining a number of items that will be recommended for the users. This is illustrated at step 315. The number of items that will be recommended is dependent on the overall level of granularity that an administrator wants for a specific system. The more recommendations that are generated it is possible to have a greater level of detail to determine which features are most relevant. In some embodiments the administrator can select this number of recommended items.

Next the process proceeds to compute the determined number of recommendations for the user based on the user's item history. The recommendations are calculated using the recommendation algorithm that is currently in use by the recommender system 100. By using the current recommendation algorithm the recommendation results are more likely to contain relevant information that can be used to select the features 256 that will be most useful to the recommender system 100. However, in other embodiments a different recommendation algorithm can be used to generate the recommendations. This is illustrated at step 320. Step 320 repeats and generates the determined number of recommendations for each of the users in the number of users.

Once the set of recommendations for each user has been determined at step 320 the process then makes a determination as to whether the similarity process for feature selection is to be analyzed based on attributes or on labels associated with each of the items. If the analysis is to be done on attributes the process follows along line 301 and if the analysis is to be done on labels the process follows along line 302. In some embodiments both attributes and labels are analyzed.

Following along for the process for attribute analysis, the process then proceeds to analyze each recommendation that was generated with each item in the user's history of items. This analysis is done for each attribute that is present for the item in the history of the item and the recommended item. During this analysis the similarity function is applied to each attribute of the items to determine the similarity between the attribute of the item in the history and the recommended item. In other words the value of attribute A for the item and the recommended item are processed through the similarity function to determine how similar the two versions of attribute A are. This is illustrated at step 325. In one embodiment a Jacard similarity function is used to determine the similarity of the attributes. However, any similarity function can be used.

The results of the similarity function are then added to a similarity measure that is associated with attribute A. This is illustrated at step 330. The process of steps 325 and 330 repeats for each of the attributes that are associated with the items. This results in a similarity measure for each attribute as against the attribute for the recommended item. Further, this process of steps 325 and 330 repeats for each recommended item and each item in the user's history.

Next the process selects a number of random items that could have been recommended to the user. The selection of a random item is illustrated at step 335. In one embodiment a single random item is selected. However, in other embodiments a number of random items may be selected. Regardless of the number of random items selected the process that occurs is the same.

Again the similarity function is applied to the random item as against the items in the user's history of items. This is illustrated at step 340. For each attribute that is associated with the random item and the items in the user's history a random similarity measure for each attribute is obtained. This is obtained by adding the results of the similarity function for each item in the history to the random similarity measure for the corresponding attribute. This is illustrated at step 345. If there are more than one random item that is used then the process of 340 and 345 repeats for each random item.

Once both the similarity measure and the random similarity measure have been calculated a ratio between the similarity measure and the random similarity measure for each attribute is calculated. This is illustrated at step 350. This is done in one embodiment by dividing the similarity measure by the random similarity measure for the particular attribute to obtain an attribute score for the attribute. The higher the resultant number represents a feature attribute that is more likely to be relevant to a recommendation than a lower number.

The results of the comparison are then presented to the administrator at step 355. In some embodiments the results may be ordered so that the administrator can review the results in a manner that allows them to understand which attributes were found more relevant than others. This approach may make it easier for the administrator to select the appropriate attributes to use in the recommender system 100.

Returning back to step 320, following the process along line 302 the process for analyzing the similarity for labels is now discussed. By analyzing labels as opposed to attributes it is possible to recognize that a subset of an attribute may be highly relevant when the attribute itself is not very relevant to making a recommendation. Similar to the process discussed above with respect to steps 325-355 each of the recommended items is compared against the items in the user's history.

However, because values of labels can vary significantly between items the process compares each label in the recommend item against each label for an item in the user's history of items. At this step the similarity function is applied to each label of the item to determine which labels are the most similar to each other. This is illustrated at step 360. Then following the determination of which label in the recommended item is most similar to the label for the item in the user's history a label similarity measure is calculated for the attribute associated with the matched label. This is illustrated at step 365. At this step the results of the similarity function for that label is added to the label similarity measure for the attribute. In some embodiments only one attribute per item in the user's history is selected based on the similarity of the labels. By only selecting one attribute to be analyzed and impacting the label similarity measure, it is possible to obtain the information related to attributes that may have relevant information contained in them that have otherwise been found to have limited relevance. In some embodiments, attributes that have already been determined to have strong correlation or relevance in the attribute analysis are ignored in the analysis. This ignoring of these attributes can improve the efficiency of the process when trying to find labels that may hold relevant information. In other embodiments a threshold level of similarity is used to determine if the process of step 365 should be performed for a specific label. The threshold level can allow for instances where more than one label is shown to have relevance between the items. In some embodiments the label similarity measure for each attribute also includes a counter to determine the number of times that the particular attribute was found to have a label similarity. In this way it is possible to exclude from consideration random occurrences where a label was found to be relevant, but not enough times to consider the match to be significant.

Following the process for determining label similarity measures for the attributes, the process selects a random item that could have been recommended to the user. The selection of a random item is illustrated at step 370. In one embodiment a single random item is selected. However, in other embodiments a number of random items may be selected. Regardless of the number of random items selected the process that occurs is the same.

Again the similarity function is applied to the random item as against the items in the user's history of items. This is illustrated at step 375. For each label associated with the attributes that are associated with the random item and the items in the user's history a random label similarity measure for each label attribute is obtained. This is obtained by adding the results of the similarity function for each item in the history to the random label similarity measure for the corresponding attribute. This is illustrated at step 380. All of the attributes are considered here from the random label similarity measure. If there are more than one random item that is used then the process of 375 and 380 repeats for each random item.

Once both the label similarity measure and the random label similarity measure have been calculated a ratio between the similarity measure and the random similarity measure for each attribute is calculated. This is illustrated at step 385. This is done in one embodiment by dividing the label similarity measure by the random label similarity measure for the particular attribute to obtain a label score for the attribute. The higher the resultant number represents a label associated with that attribute is more likely to be relevant to a recommendation than a lower number.

The results of the comparison are then presented to the administrator at step 390. In some embodiments the results may be ordered so that the administrator can review the results in a manner that allows them to understand which label attributes were found more relevant than others. This approach may make it easier for the administrator to select the appropriate attributes to use in the recommendation system. In some embodiments the results of steps 355 and 390 are presented to the administrator at the same time such that the administrator may appreciate subtle attributes as against attributes as a whole.

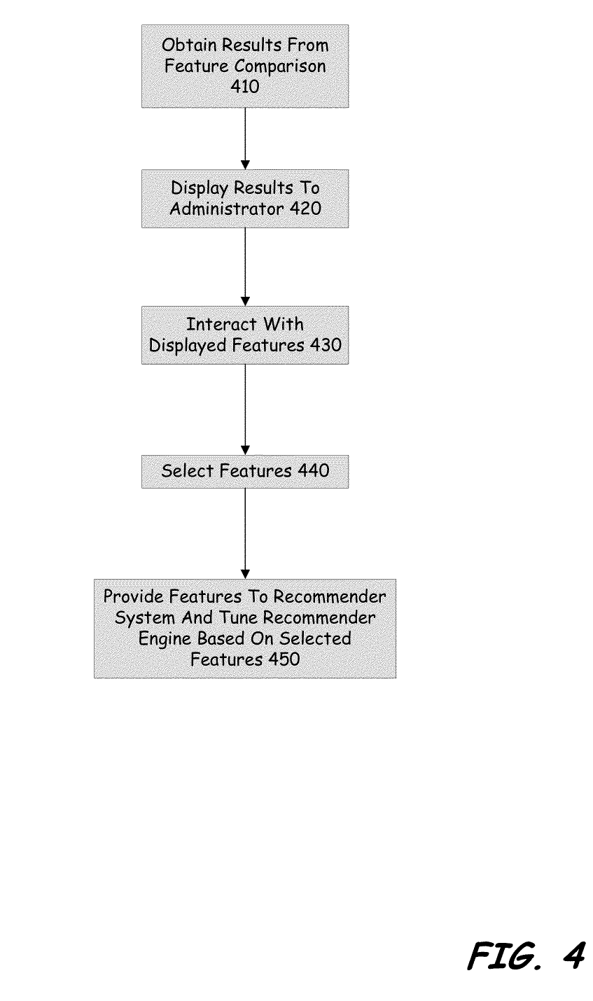

FIG. 4 is a flow diagram illustrating an exemplary process for selecting features and tuning the recommendation engine according to one illustrative embodiment. In one embodiment this process is handled by the exploration tool 230 through the user interface 275.

The results of the feature comparison are obtained by the exploration tool 230 from the feature scorer 220 at the feature tuning model of the recommender system 100 at step 410. In one embodiment the results that are obtained are the results of from the comparison of the attribute similarity measure to the random attribute similarity measure. In another embodiment the results that are obtained are the results from the comparison of the label similarity measure to the random label similarity measure. In yet another embodiment the results are the combination of the attribute and label similarity measure comparisons.

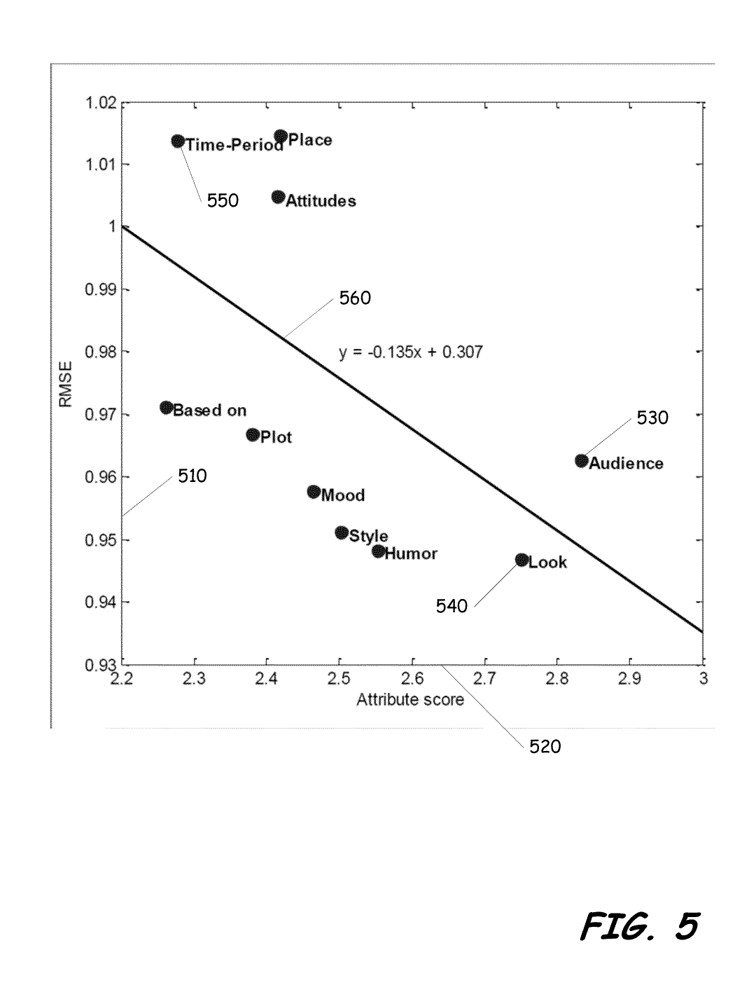

The results of the comparison are then provided on a graphical user interface such that the administrator can visually appreciate the value of specific features and how they influence recommendations received from the recommender system 100. This is illustrated at step 420. In one embodiment the graphical user interface displays the features ranked by their associated score. This may be presented in a table or other format that allows the administrator to understand the results. In another embodiment the graphical user provides the administrator with a graph or plot whereby the features are graphed by their score as against the Root Mean Squared Error measure of quality. An example of a graph that may be presented to the user is illustrated in FIG. 5.

FIG. 5 illustrates the results of the attribute scoring for movies attributes across one example dataset. In this example, movies in the dataset are associated with labels. Each label is associated with a category or attribute, e.g., Audience, Mood, Plot. Every movie has zero or more labels for each category. The Audience category can have labels such as Kids, Girls Night, Family, etc. The Look category has labels such as 3D, Black and white and Animation; The Time-period category has labels indicating the time in which the plot takes place (e.g. decade, generation, event, roaring twenties, civil war, future, etc). The information in this dataset is used for evaluating both attribute and label ranking scores in the process for feature scoring such as the process discussed above with respect to FIG. 3.

In one embodiment each of the label categories is treated as a distinct attribute. Then the system reconstructs, for example, a sample of 1,500 movies, and compute RMSE for each category. FIG. 5 depicts the RMSE results 510 vs. the attribute scores 520. In this example, categories such as Audience 530 and Look 540 were found to be more informative than categories like Time-period 550. A trend line 560 illustrates a negative correlation between the attribute scores and the RMSE results.

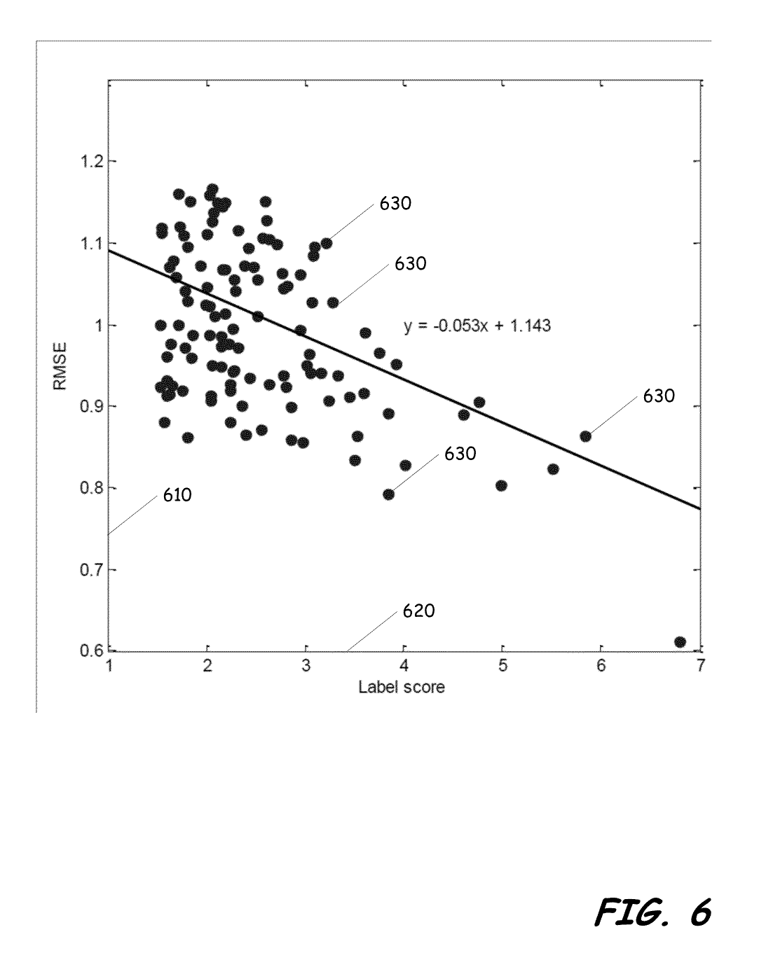

FIG. 6 illustrates the results of the scoring process for movie labels across on example dataset. In the present embodiments different labels from the same category may have a different informative values. For example, the Place category is in the general non-informative category, as for most movies it simply takes the label “USA”. Nevertheless, for a small subset of movies, this category carries a label such as “Ghetto” which can correlate highly with individuals who might watch the movie. The present embodiment therefore evaluates labels separately, ignoring categories. However, in other embodiments category may be considered. This can occur where the label is the same label between two categories, but carries a different meaning. (e.g. Movies for Girls and Movies about Girls). Each dot 630 on the chart represents a specific label. In some embodiments, the administrator may interact with the displayed graph by clicking on a dot 630. By clicking on the dot 630 the administrator may be presented with information related to the specific label, such as the label name and associated category or attribute.

The administrator can then interact with the user interface 275 to understand more about why a particular feature is presented and how it correlates with other features. This is illustrated at step 430. The administrator can then select the features from the user interface 275 that were found to be the most relevant or informative in making a recommendation to a user. This is illustrated at step 440. In one embodiment the administrator selects the top 4 features. However, any number of features may be selected. The more features that are selected generally the slower the recommender system 100 will respond and may also cause more irrelevant recommendations to be made. At step 450 the selected features are provided to the recommender system 100 so that the recommendation algorithm can be adjusted or tuned to make recommendations based on the selected features. The actual process for adjusting the recommendation algorithm is not discussed herein.

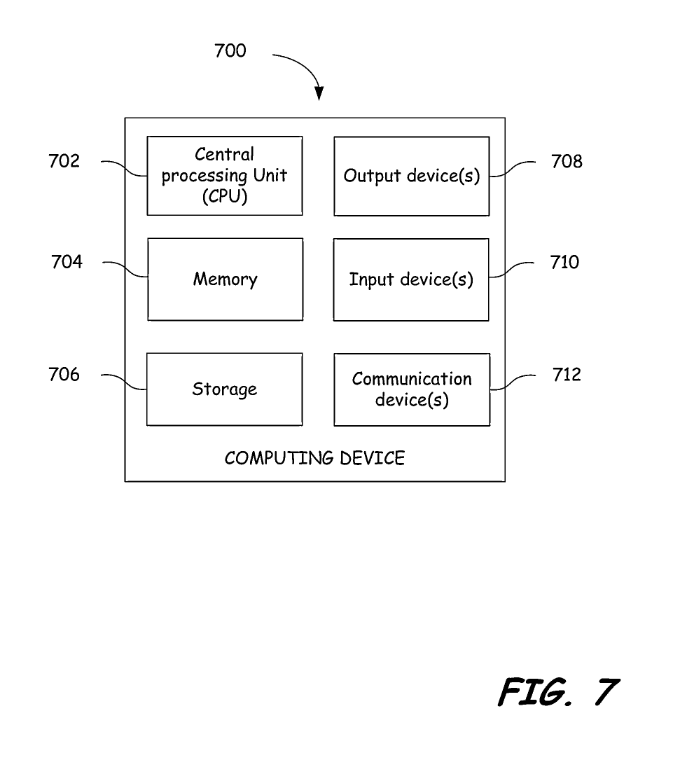

FIG. 7 illustrates a component diagram of a computing device according to one embodiment. The computing device 700 can be utilized to implement one or more computing devices, computer processes, or software modules described herein. In one example, the computing device 700 can be utilized to process calculations, execute instructions, receive and transmit digital signals. In another example, the computing device 700 can be utilized to process calculations, execute instructions, receive and transmit digital signals, receive and transmit search queries, and hypertext, compile computer code, as required by the system of the present embodiments. Further, computing device 700 can be a distributed computing device where components of computing device 700 are located on different computing devices that are connected to each other through network or other forms of connections. Additionally, computing device 700 can be a cloud based computing device.

The computing device 700 can be any general or special purpose computer now known or to become known capable of performing the steps and/or performing the functions described herein, either in software, hardware, firmware, or a combination thereof.

In its most basic configuration, computing device 700 typically includes at least one central processing unit (CPU) 702 and memory 704. Depending on the exact configuration and type of computing device, memory 704 may be volatile (such as RAM), non-volatile (such as ROM, flash memory, etc.) or some combination of the two. Additionally, computing device 700 may also have additional features/functionality. For example, computing device 700 may include multiple CPU's. The described methods may be executed in any manner by any processing unit in computing device 700. For example, the described process may be executed by both multiple CPU's in parallel.

Computing device 700 may also include additional storage (removable and/or non-removable) including, but not limited to, magnetic or optical disks or tape. Such additional storage is illustrated in FIG. 5 by storage 706. Computer storage media includes volatile and nonvolatile, removable and non-removable media implemented in any method or technology for storage of information such as computer readable instructions, data structures, program modules or other data. Memory 704 and storage 706 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing device 700. Any such computer storage media may be part of computing device 700.

Computing device 700 may also contain communications device(s) 712 that allow the device to communicate with other devices. Communications device(s) 712 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer-readable media as used herein includes both computer storage media and communication media. The described methods may be encoded in any computer-readable media in any form, such as data, computer-executable instructions, and the like.

Computing device 700 may also have input device(s) 710 such as keyboard, mouse, pen, voice input device, touch input device, etc. Output device(s) 708 such as a display, speakers, printer, etc. may also be included. All these devices are well known in the art and need not be discussed at length. Those skilled in the art will realize that storage devices utilized to store program instructions can be distributed across a network. For example a remote computer may store an example of the process described as software. A local or terminal computer may access the remote computer and download a part or all of the software to run the program. Alternatively the local computer may download pieces of the software as needed, or distributively process by executing some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

1. A method for determining relevant features for making recommendations, comprising:
obtaining a history of items associated with a first user of a plurality of users of a marketplace;
generating at least one recommended item for the first user from an item catalogue;
determining a first similarity measure between a first feature of the at least one recommended item and a corresponding first feature for an item in the history of items associated with the first user;
selecting at least one random item from the item catalogue;
determining a first random similarity measure between the first feature of the random item and the corresponding first feature for the item in the history of items; and
calculating a similarity ratio between the first similarity measure and the first random similarity measure for the first feature.

2. The method of claim 1 further comprising:
determining a second similarity measure between a second feature of the at least one recommended item and a corresponding second feature for an item in the history of items associated with the first user;
determining a second random similarity measure between the second feature of the random item and the corresponding second feature for the item in the history of items; and
calculating a second similarity ratio between the second similarity measure and the second random similarity measure for the second feature.

3. The method of claim 1 further comprising
obtaining a history of items associated with a second user of a plurality of users of a marketplace;
generating at least one recommended item for the second user from an item catalogue;
determining the first similarity measure between the first feature of the at least one recommended item and the corresponding first feature for an item in the history of items associated with the second user;
adding the determined first similarity feature for the second user with the determined first similarity feature for the first user;
determining the first random similarity measure between the first feature of the random item and the corresponding first feature for the item in the history of items for the second user;
adding the determined first random similarity measure for the second user with determined first random similarity measure for the first user; and
calculating a similarity ratio between the first similarity measure and the first random similarity measure for the first feature wherein the first similarity measure and the first random similarity measure are based on the added similarity measures.

4. The method of claim 3 further comprising:
determining the second similarity measure between the second feature of the at least one recommended item and a corresponding second feature for an item in the history of items associated with the second user;
adding the determined second similarity feature for the second user with the determined second similarity feature for the first user;
determining the second random similarity measure between the second feature of the random item and the corresponding second feature for the item in the history of items;
adding the determined second random similarity measure for the second user with determined second random similarity measure for the first user;
calculating the second similarity ratio between the second similarity measure and the second random similarity measure for the second feature.

5. The method of claim 3 further comprising:
repeating the steps for a third or subsequent user in the plurality of users.

6. The method of claim 5 wherein repeating further comprising:
selecting a set of users from the plurality of users; and
repeating the steps for each member of the set of users.

7. The method of claim 6 wherein selecting a set of users comprises selecting at least two different sets of users.

8. The method of claim 1 wherein the feature is an attribute.

9. The method of claim 1 wherein the feature is a label.

10. The method of claim 2 further comprising:
determining a third or subsequent similarity measure between a third or subsequent feature of the at least one recommended item and a corresponding third or subsequent feature for an item in the history of items associated with the first user;
determining a third or subsequent random similarity measure between the third or subsequent feature of the random item and the corresponding third or subsequent feature for the item in the history of items; and
calculating a third or subsequent similarity ratio between the third or subsequent similarity measure and the third or subsequent random similarity measure for the second feature.

11. The method of claim of claim 10 further comprising:
ordering each of the calculated similarity ratios; and
presenting the ordered calculated similarity ratios on a user interface.

12. The method of claim 10 further comprising:
displaying each of the calculated similarity ratios on a user interface.

13. The method of claim 10 further comprising:
modifying a recommender engine based on the calculated similarity ratios.

14. A system for identifying features of significance for use in a recommender system comprising:
at least one processor;
at least one storage device an item catalogue comprising a plurality of items, each of the plurality of items having a plurality of features associated with the item;
a user data database configured to store user profile data for a plurality of users, each user profile in the user data database comprising a history of items available from the item catalogue that are associated with the user;
a recommender engine configured to generate at least one recommendation for an item in the item catalogue for a first user in the user data database; and
a feature scorer configured to determine a similarity measure for at least one feature associated with the at least one recommended item and a corresponding at least one feature for items in the history of items associated with the first user, and to determine a random similarity measure for the at least one feature associated with a random item from the item catalogue and the corresponding at least one feature for items in the history of items associated with the first user.

15. The system of claim 14 wherein the feature scorer is further configured to determine a similarity ratio for the at least one feature between the similarity measure and the random similarity measure.

16. The system of claim 15 further comprising:
an exploration tool configured to permit an administrator to view the similarity ratio determined by the feature scorer.

17. The system of claim 16 wherein the exploration tool is further configured to permit the administrator to modify preferences for the recommender engine based on the similarity ratio

18. The system of claim 14 further comprising
wherein the recommender engine is further configured to generate at least one recommendation for an item in the item catalogue for a second user in the user data database; and
wherein the feature scorer is further configured to determine the similarity measure for the at least one feature associated with the at least one recommended item and the corresponding at least one feature for items in the history of items associated with the second user, add the determined similarity measure to a previously determined similarity measure for the at least one feature, to determine the random similarity measure for the at least one feature associated with the random item and the corresponding at least one feature for items in the history of items associated with the second user, and add the determined random similarity measure to a previously determined random similarity measure for the at least one feature.

19. The system of claim 14 wherein the recommender engine is configured to provide recommendations for a set of users of the plurality of users, wherein the set of users share at least one common characteristic in the user profile.

20. A computer readable storage medium having computer readable instructions that when executed by a computer having a least one processor cause the computer to:
obtain a set of item histories for a plurality of users of a recommender system;
generate a set of recommend items for each of the plurality of users from an item catalogue;
determine a similarity measure for each feature of each item in the set of recommend items for each of the plurality of users and for a corresponding feature of each item in the set of item histories for each of the plurality of users;
select a random item for the item catalogue;
determine a random similarity measure for each feature of the random item and for a corresponding feature of each item in the set of item histories for each of the plurality of users;
compare the similarity measure for each feature with the random similarity measure for the corresponding feature to obtain a similarity ratio for each feature; and
display the similarity ratio to an administrator.
